(19) United States
(12) Patent Application Publication
(10) Pub. No.: US 2002/0069060 A1
(43) Pub. Date: Jun. 6, 2002

(54) Method and system for automatically managing a voice-based communications systems

(76) Inventors: Samuel Cannavo, Boston, MA (US); Martin LeBrun, Jeffersonville, PA (US); Kasturi Mudambi, Newtown Square, PA (US)

Correspondence Address: FOLEY, HOAG & ELIOT, LLP, PATENT GROUP, ONE POST OFFICE SQUARE, BOSTON, MA, 02109, US

(21) Appl. No.: 09/858,134

(22) Filed: May 15, 2001

Related U.S. Application Data
(60) Provisional application No. 60/204,167, filed on May 15, 2000.

(51) Int. Cl. G10L 15/00

(52) U.S. Cl. 704/257

(57) ABSTRACT

The present invention provides a subscriber with a single interface to access one or more Voice-Based Communications Systems (hereinafter “VCSs”). By employing automatic speech recognition and/or natural language understanding (hereinafter “ASR/NLU”) technologies and capabilities, the system can interact with a VCS account without direct human interaction. The system logs into a VCS account by generating voice commands (e.g., using text to speech technology or recorded voice commands) and/or DTMF, and then precedes to conduct an automated voice-based dialogue with the VCS in order to obtain notification, voice communications and/or other information. Since the system employs ASR/NLU technologies and capabilities, it can record any notifications and communications from the VCS, optionally convert them into other data signals (e.g., digital data) and then transmit them over and/or store them on other mediums.

### REFERENCE TO RELATED APPLICATIONS

This application claims priority to U.S. Provisional Application No. 60/204,167 entitled “Method and System for Automatically Managing a Voice-based Communication System,” filed May 15, 2000, which is hereby incorporated by reference in its entirety.

Additionally, this application incorporates in its entirety each reference cited herein, including but not limited to published patent applications, patents, articles, and books. Specifically, U.S. patent application Ser. No. 09/565,190 entitled “Unified Messaging System” filed May 3, 2000 is hereby incorporated by reference in its entirety.

### FIELD OF THE INVENTION

The present invention relates to managing communications and information (including but not limited to, voice mail and financial information) on a communications system. More particularly, the invention relates to a method and system that employs automatic speech recognition and/or natural language understanding techniques and capabilities to manage (including but not limited to, access, organize, retrieve, save, and format) communications on a Voice-Based Communications System (e.g., a voice mail system, an Interactive Voice Response system, a Unified Messaging System, etc.).

### BACKGROUND OF THE INVENTION

Telecommunications providers offer users and subscribers a wide variety of Voice-Based Communications Systems (hereinafter “VCSs”), such as voice mail systems and Interactive Voice-Based Response Systems (hereinafter “IVRSs”), which further include banking services, news services, security/stock/commodity trading services, customer information services, and the like. Indeed, VCSs have proven to be a valuable tool to, among other things, communicate with friends and colleagues, transact business, manage finances, and keep abreast of the news and other current information. As used herein, a VCSs is any communications and/or information service that generates voice prompts and requires some type of real-time human interaction in order to access stored communications and/or information (including but not limited to, voice messages and stock quotes) thereon. Typically, such real-time human interaction results from a subscriber speaking into the microphone of a telephone set and/or pressing the keys on the keypad of a telephone set.

Conventional VCSs interact with a user or subscriber by using the telephone set as an input/output device. Typically, a subscriber dials into her VCS account (e.g., a voice mail system) with a standard telephone set, a wireless telephone set, or the like, and then, the VCS plays a prerecorded human and/or synthesized voice message summary to inform her that she has a certain number of new communications (e.g., voice messages) in her account (e.g., a voice mail box). Next, the VCS usually allows the subscriber to access her communications by playing pre-recorded human and/or synthesized voice prompts, and then, listening to her responses. The subscriber may respond to the voice prompts and make selections by speaking into the microphone of her telephone set and/or by pressing the keys of her telephone set's keypad (e.g., in accordance with DTMF or pulse technology). The VCS then proceeds according to the subscriber's selection(s)—.g., by playing back a voice message, deleting a voice message, forwarding a voice message to another destination, playing back a financial news report, and the like.

VCSs that are currently provided by telecommunications providers are (for the most part) proprietary, and thus, a subscriber is limited to the notification features of the VCS to which he or she subscribes. For example, in order for a subscriber to know whether she has any new communications, she usually has to resort to dialing into her VCS account and listening to a voice message summary (as discussed above). Alternatively, in some cases, additional products/services can be purchased (i.e., from the telecommunications provider of the VCS) that inform a subscriber of any new messages that are in her account. Such products/services, which tend to be relatively expensive, include: paging notification services wherein a subscriber's pager may beep and/or receive a short text or numeric message; telephone sets having flashing “message indicator lights;” “stuttered dial tone” features wherein when a subscriber picks up the telephone, the dial tone is different than normal (e.g., gaps in the dial tone are played in rapid sequence); wireless phone and message waiting services wherein an icon is shown on the display of a wireless phone; and e-mail forwarding services wherein short text messages are sent to a subscriber's e-mail address. Even with these additional products/services, however, a subscriber is still limited to proprietary technology having rigid boundaries.

Besides providing a subscriber with scant notification features, the proprietary nature of conventional VCSs provide little (if any) “open” interfaces/protocols that allow access to a subscriber's communications (e.g., voice messages). That is, today's VCS products/services generally use hardwired transceiving and protocol conversion equipment dedicated to a particular type of equipment and communications format/protocol. Consequently, VCS access is limited to using a telephone set in real-time and to a particular telecommunications provider's access and management features. For example, if a subscriber wants to forward a stored message from a conventional VCS account to a colleague, she is often limited to forwarding an audio voice message; and in some cases, she is not even able to do that. Additionally, most telecommunications providers allow a subscriber to save only a limited number of messages in her account at one time. Thus, if a subscriber is approaching her limit, but she wishes to save all of her messages, she is unable to do so. Of course, she could re-record her voice messages if she has a telephone set with an audio recording device, but often, this results in a record having poor quality. Moreover, she has no way of storing the messages on another medium (e.g., a computer disk) for record-keeping purposes.

Although there are some telecommunications standards that are known to those skilled in the art—.g., AMIS-Analog, AMIS-Digital, VPIM, and VMUIF—they offer a subscriber little (if any) additional control in managing her VCS account since they: are not widely followed; are often limited to other VCSs; involve the tracking of routing information; and often require licenses. Thus, today's VCSs provide limited features and very few open standards. Worst of all, in order to manage messages on a conventional VCS account, real-time human interaction is always required.

Therefore, there is a need for a method and system that overcomes these deficiencies, in terms of increased system adaptability/flexibility, so as to allow a subscriber to monitor/manage the communications in her VCS account without being restricted by the telecommunications provider's proprietary technology.

### SUMMARY OF THE INVENTION

The methods and systems described herein include embodiments that overcome the limitations of conventional Voice-Based Communications Systems (hereinafter “VCSs”) by employing automatic speech recognition and/or natural language understanding (hereinafter “ASR/NLU”) technologies and capabilities to emulate a human voice and interact with a VCS account. The system logs in to a VCS account by generating voice commands (e.g., synthesized using text to speech technology or recorded voice commands) and/or DTMF, and then proceeds to conduct an automated voice-based dialogue with the VCS in order to obtain notification and/or communications information. Since the system employs ASR/NLU technologies and capabilities, it can record any notifications and communications from the VCS and convert them into other data signals (e.g., digital data) which can then be transmitted over and/or stored on other mediums.

In one embodiment, a system employing the invention, connects to a VCS by placing a telephone call to a VCS. From there, the VCS plays back voice prompts containing pre-recorded or synthesized voice to the system. The system receive the voice audio of the voice prompts from the VCS and utilizing ASR/NLU, determine information from the VCS prompts. In addition, based on this information the system may interact with the VCS by sending the applicable command as if it was a live user by sending telephone keypad digits or sending audio commands as required by the VCS.

In one embodiment, the invention provides a method for receiving information from a Voice-Based Communications System (VCS) account, with a voice-based interface by providing an Automatic Speech Recognition and Natural Language Understanding application (ASR/NLU application) with access data and control data for the VCS account and communicating between the ASR/NLU application and the voice-based interface; and using the ASR/NLU application to respond to the voice-based interface so as to receive information from the VCS account. The ASR/NLU can respond to the voice based interface using an audio tone, a DTMF tones, a pulse tone, a synthesized voice, or a pre-recorded voice. The access and control data for the VCS account can be stored in a computer database and provided to the application. The ASR/NLU application and the voice based interface can communicate through a public switched telephone network, a private telephone network, a wireless telephone network, a voice carrier over a data protocol, or voice over IP.

In a further embodiment, a VCS account subscriber is notified when information has been received by the VCS account. The subscriber can subsequently receive the information from the VCS account. The subscriber can be notified by a facsimile, an instant message, an email, an updated web page, a page, a wireless access device or a telephone call. The information provided by the VCS can include financial information, voice messages, stock quotes, news, entertainment information, sports scores, horoscopes, a prediction, or a reminder. In one embodiment, the information from the VCS is provided on a fee per call basis.

Another aspect of the invention includes a system for managing a Voice-Based Communications System (VCS) account, having a voice-based interface that transmits voice-prompts and receives responses thereto, with an Automatic Speech Recognition and Natural Language Understanding application (ASR/NLU application); a transceiver to communicate information between the VCS account and the application; and a database to store the information received by the application from the VCS account. The transceiver can be configured to communicate with a client through a communications network and the application being configured to provide the client with the information received by the application from the VCS account. In another embodiment, the application can be configured to receive from the client the VCS account access data and VCS account interface control data.

Other objects of the invention will, in part, be obvious, and, in part, be shown from the following description of the systems and methods shown herein.

### BRIEF DESCRIPTION OF THE DRAWINGS

The foregoing and other objects and advantages of the invention will be appreciated more fully from the following further description thereof, with reference to the accompanying drawings.

FIG. 1 depicts schematically the structure of a system according to one embodiment of the invention that employs a computer network to automatically manage one or more Voice-Based Communications Systems with Automatic Speech Recognition and/or Natural Language Understanding technologies and capabilities; and

FIG. 2 depicts in more detail the structure of a system of FIG. 1 for automatically managing one or more Voice-Based Communications Systems with Automatic Speech Recognition and/or Natural Language Understanding technologies and capabilities.

FIG. 3 shows an embodiment of the invention where the presence of information is detected and output to a user.

FIG. 4 illustrates process through which a user navigates a system of the invention.

FIG. 5 depicts a flow chart for a method of the invention to manage a VCS.

FIG. 6 shows a device in accordance with one embodiment of the invention.

### DESCRIPTION OF THE ILLUSTRATED EMBODIMENTS

To provide an overall understanding of the present invention, certain illustrative embodiments will now be described, including a method and system for automatically managing one or more Voice-Based Communications Systems (hereinafter “VCSs”) and/or Unified Messaging Systems. However, it will be understood by one of ordinary skill in the art that the system(s) and method(s) described herein can be adapted and modified for other suitable application(s) and that such other addition(s) and modification(s) will not depart from the spirit and scope of the inventive concept.

To more clearly and concisely describe the subject matter of the present invention, the following definitions are intended to provide guidance as to the meaning of specific terms used in the following written description, examples, and appended claims. As used herein, the phrase “communications network” and the term “network” includes a public switched telephone network (PSTN), a private telephone network, a wireless telephone network, voice carrier over data protocols such as voice over IP (VoIP), and any network that can carry audio signals including voice. As used herein, the phrase “service provider” includes entities that provide communications products/services, information products/services, and the like, including telecommunications providers, financial service providers, Internet Service Providers (hereinafter “ISPs”), Internet Access Providers (hereinafter “IAPs”), Application Service Providers (hereinafter “ASPs”), and the like. As used herein, the phrase “Wireless Access Device” (hereinafter “WAD”) includes mobile telephones, cellular telephones, palm-pilots, pagers, beepers, and other various hand-held wireless devices that are familiar to those skilled in the communications and information transfer/access art. As used herein, the phrase “Internet Access Device” (hereinafter “IAD”) includes personal computer systems (hereinafter “PCs”), computer workstations, desktop computers, laptop computers, WADs, and all other devices that are capable of accessing the Internet. As used herein, the phrase “Automatic Speech Recognition” (hereinafter “ASR”) includes the field of computer science that deals with designing computer systems and applications that can automatically recognize and process spoken words. As used herein, the phrase “Natural Language Understanding” (hereinafter “NLU”) includes the field of computer science that deals with designing computer systems and applications that can automatically understand and process human languages.

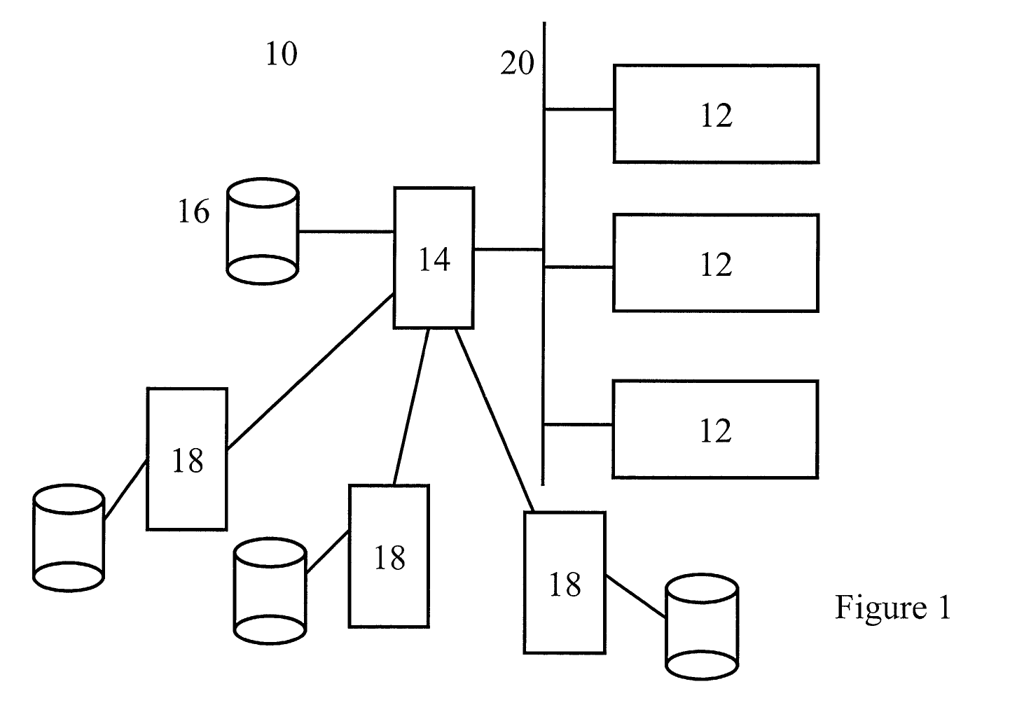

FIG. 1 depicts an illustrative embodiment of one system 10 according to the invention for automatically managing a conventional VCS with an application that employs ASR and/or NLU (hereinafter an “ASR/NLU application”) technologies and capabilities, including but not limited to, text to speech (hereinafter “TTS”) technologies and capabilities. Specifically, FIG. 1 illustrates a system 10 wherein a subscriber system(s) 12 connects through a communications network 20 to a server 14. The server 14 connects to and maintains either a proprietary or a non-proprietary database 16. The server 14 also connects (optionally by direct secure lines) to a system(s) that is provided by a service provider(s) 18, such as a VCS (as discussed in the background). The elements of the system 10 can include commercially available systems that have been arranged and modified to act as a system according to the invention, which allows a subscriber to flexibly manage a VCS account 18, and optionally generate digital records of communications (e.g., voice messages) that are stored in her VCS account 18 (e.g., a voice mail system).

For the illustrative embodiment depicted in FIG. 1, the system 10 employs the Internet to allow a subscriber at a remote client, such as the subscriber system 12, to access and login to an account maintained by the central server 14, and to employ the services provided to that account to automatically manage a separate VCS account(s) 18 with an ASR/NLU application. For example, the server 14 can present the subscriber with an HTML page that acts as a graphical user interface (hereinafter a “GUI”). Through this GUI (not shown), the subscriber can program the system 10 to automatically access, retrieve, and manage communications in one or more of her separate VCS accounts 18 by employing an ASR/NLU application. For example, the subscriber can type access information—e.g., her user id, password, access number, PIN, and the like—into the text input fields of the GUI for one of her VCS accounts 18, and then “click-on” an enter button so as to register the information with the system 10. Further, the subscriber can type control information—e.g., the frequency at which the ASR/NLU application will access her VCS account—into the text input fields of the GUI, and then “click-on” an enter button so as to register the information with the system 10.

After being programmed with the appropriate access and control information, the system 10 has the ability to access and interact with the subscriber's VCS account without any human interaction. That is, the system 10 can conduct a dialog with the VCS account 18 so as to provide a user interface different from that provided by the telecommunications provider. The control information entered by the subscriber can direct the ASR/NLU application to automatically forward any messages received by her VCS account 18 to another communications medium, such as an e-mail account, a different telephone set, an IAD, a WAD, a Web site account, and the like. The subscriber can also enter control information that directs the ASR/NLU application to digitize and record all received messages on another communications medium, such as the hard drive of a computer system.

Additionally, the subscriber can specify notification features beyond those offered by the telecommunications provider of her VCS account 18. For example, without relying on the products/services of a specific telecommunications provider (as discussed in the background), the subscriber can enter information that will program the system 10 to notify her of any new messages in her VCS account 18 by paging her on any pager, forwarding an e-mail to any e-mail system, notifying her on any WAD or IAD, and the like. Thus, by employing the system 10, a subscriber is not limited by the proprietary technology of her VCS account 18.

In operation, the ASR/NLU application of the system 10 calls into the subscriber's VCS account 18 (e.g., a voice mail system) using DTMF or pulse technology. Then, the ASR/NLU application, having been programmed with the appropriate voice commands and/or digits and having the capability to understand voice prompts from the VCS 18, can automatically manage communications in the subscriber's VCS account 18. Depending on the type of VCS account 18 (e.g., voice messaging system, banking service, etc.), the ASR/NLU application conducts a dialog with the VCS 18 to obtain the number and content of messages, account balances, and other information. For example, the ASR/NLU application can interact with a message review menu of a VCS account 18 to manage messages by responding to voice prompts (e.g., Press 2 to save the message, 3 to erase it, 4 to reply, 5 to copy, # to skip to the next message, etc.) with TTS and/or pre-recorded human speech and/or synthesized speech.

In one scenario, the VCS 18 may play a prompt saying “You have two new voice messages.” Using ASR and optionally NLU, the ASR/NLU application can automatically understand the voice prompt and respond according to the control information that was entered by the subscriber (as previously discussed). For example, if on Sundays the subscriber is usually at her beach house, she can program the system 10 so that the ASR/NLU application forwards all new messages that are received on Sundays to the telephone number for her beach house. Alternatively, she can program the system 10 so that the ASR/NLU application forwards all new messages that are received on Sundays to her e-mail account (at work) as an embedded voice file. Further, if so desired, the subscriber could program the system 10 so that the ASR/NLU application converts all new messages into text (e.g., by employing TTS technology), and then, forwards the text messages to her e-mail account and/or to the display of a WAD (e.g., a pager having a micro-display) and/or to a facsimile machine. Thus, the invention removes the need for the subscriber to interact with the real-time VCS interface that is provided by her telecommunications provider. However, the invention still allows the subscriber to access her VCS in real-time if so desired.

Regardless of the technical limitations of a particular VCS account 18 (as discussed in the background), a subscriber can program the system 10 to retrieve communications from her VCS account 18 and then provide her with notification services that do not depend on her telecommunications provider's proprietary technology. To this end, the subscriber can program the system 10 with a schedule for where and how she wishes to be notified. In operation, the ASR/NLU application automatically calls into the subscriber's VCS account 18 (as discussed above) at various points in time, which are specified by the control information that the subscriber previously entered (as discussed above). Once the ASR/NLU application has gained access to the account 18 (e.g., a voice mailbox), the ASR/NLU application listens to the voice prompts played back by the VCS 18. If there are new messages, then the ASR/NLU application automatically forwards them to the notification products/services that the subscriber specified with the control information. Such notification products/services can include any e-mail account, any IAD, any WAD, any telephone set, and the like.

The ASR/NLU application can also employ a phonetic algorithm to parse out and determine the intended meaning of voice prompts that are generated by a VCS 18 as well as the intended meaning of communications that are residing in a subscriber's VCS account 18. For example, the ASR/NLU application can distinguish between “You have two new voice messages” and “You have no new messages” and “You have two saved messages.” Using ASR and optionally NLU, the ASR/NLU application can also understand different ways of saying the same thing and filter out other information. For example, the ASR/NLU application can understand “There are two new messages in your mailbox,” “Two new messages have arrived,” and the like. Further, the ASR/NLU application can understand different voices by employing speaker independent speech recognition. Optionally, the ASR/NLU application may be programmed to understand different languages and/or to convert communications from one language to another language and/or to save communications in different languages and in different formats (including but not limited to a voice file or a text file).

Where a subscriber has multiple VCSs 18, the system 10 can be used to make each VCS 18 have the same “feel,” thereby removing the need for a subscriber to remember multiple interfaces, user ids, passwords, access numbers, PINs, and the like. After the subscriber enters all of the access and control information for each VCS account 18 (e.g., by using the GUI as previously discussed), the system 10 can automatically manage each VCS account 18 from one central location, such as the server 14 depicted by FIG. 1. From this central location, the subscriber can access all of her VCS accounts 18 either in real-time or in non-real-time by acting through a Web-based interface, such as a GUI similar to the previously discussed GUI.

In fact, using the phonetic algorithm and/or ASR and/or NLU, the ASR/NLU application can simultaneously access each VCS account 18 and convert the different voice prompts of each account 18 into unified voice prompts, thereby enabling the subscriber to access each VCS account 18 at the same time by responding to the same exact voice prompts. For example, if VCS X, VCS Y, and VCS Z are all empty (e.g., none of them have any voice messages), then: VCS X may have a voice prompt that says “There are no messages;” whereas VCS Y may have a voice prompt that says “Your mail box is empty;” whereas VCS Z may have a voice prompt that says “You have zero messages.” The ASR/NLU application can access each VCS account 18 and return a single unified voice prompt to the subscriber, such as “Empty mail box” via an IAD, WAD, telephone set, and the like.

Turning now to the elements that compose the system 10 depicted in FIG. 1, it can be seen that the system 10 includes a network based system that includes a plurality of client systems 12 that connect through a network 20, such as the Internet IP network, or any suitable network, to a server system 14. The server 14 can connect over dedicated channels, over the Internet, or by other means to one or more VCS account(s) 18.

For the depicted system 10, the client system(s) 12 can be a telephone or any suitable computer system such as a PC workstation, a handheld computing device, a WAD, or any other such IAD, equipped with a network client capable of accessing a network server and interacting with the server to exchange information. As previously discussed, in one embodiment the network client 12 is a Web client that enables the subscriber to exchange data with a Web server, a FTP server, a gopher server, or some other type of network server. The Web client 12 can include a Web browser such as the Netscape Web browser, the Microsoft Internet explorer Web browser, the Lynx Web browser, or a proprietary Web browser. The client 12 can employ an unsecured communications path, such as the Internet, for accessing services on the remote server 14. To add security to such a communications path, the client 12 and the server 14 can employ a security system, such as any of the conventional security systems that have been developed to provide to the remote subscriber a secured channel for transmitting data over the Internet. One such system is the Netscape secured socket layer (hereinafter “SSL”) security mechanism that provides to a remote subscriber 12 a trusted path between a conventional Web browser program and a Web server. Therefore, optionally and preferably, the client system(s) 12 and the server system 14 have built in 128 bit or 40 bit SSL capability and can establish an SSL communication channel between the clients 12 and the server 14. Other security systems can be employed, such as those described in Bruce Schneir, Applied Crytpography (Addison-Wesley 1996). Alternatively, the systems may employ, at least in part, secure communication paths for transferring information between the server 14 and the client(s) 12. For purposes of illustration, however, the systems described herein, including the system 10 depicted in FIG. 1 will be understood to employ a public channel, such as an Internet connection through an ISP or any suitable connection, to connect the subscriber system(s) 12 and the server 14.

The server 14 may be supported by a commercially available server platform such as a Sun Sparc™ running a version of the Unix operating system and running a server capable of connecting with, or exchanging data with, one of the subscriber systems 12. In the embodiment of FIG. 1, the server 14 includes a Web server, such as the Apache Web server or any suitable Web server. The Web server component of the server 14 acts to listen for requests from subscriber systems 12, and in response to such a request, resolves the request by identifying a filename and/or script, dynamically generating data that can be associated with that request, and returning the data to the requesting subscriber system 12. The operation of the Web server component of the server 14 can be understood more fully from Laurie et al., Apache The Definitive Guide, O'Reilly Press (1997). The server 14 may also include components that extend its operation to: interface with one or more VCS accounts 18 and/or Unified Messaging Systems 18; and/or to manage one or more VCS accounts 18 and/or Unified Messaging Systems 18; and/or to provide a subscriber with flexible notification features from one or more VCS accounts 18 and/or Unified Messaging Systems 18. Therefore, it is understood that the architecture of the server 14 may vary according to the application. For example, the Web server may have built in extensions, typically referred to as modules, to allow the server 14 to interface with one or more VCS accounts 18 and/or Unified Messaging Systems 18, or the Web server may have access to a directory of executable files, each of which files may be employed for performing the operations, or parts of the operations, that implement the methods and systems of the present invention.

The server 14 may couple to a database 16 that stores information representative of a subscriber's account, including information about the different VCSs 18 and/or Unified Messaging Systems 18 that the subscriber uses and information regarding the subscribers accounts, including passwords, subscriber accounts, subscriber privileges, and similar information. The depicted database 16 may comprise any suitable database system, including the commercially available Microsoft Access database, and it can be either a local or a distributed database system. The design and development of database systems suitable for use with the system 10, follow from principles known in the art, including those described in McGovern et al., A Guide To Sybase and SQL Server, Addison-Wesley (1993). The database 16 can be supported by any suitable persistent data memory, such as a hard disk drive, RAID system, tape drive system, floppy diskette, or any other suitable system. The system 10 depicted in FIG. 1 includes a database device 16 that is separate from the server station platform 14; however, it will be understood by those of ordinary skill in the art that in other embodiments, the database device 16 can be integrated into the actual server system 14.

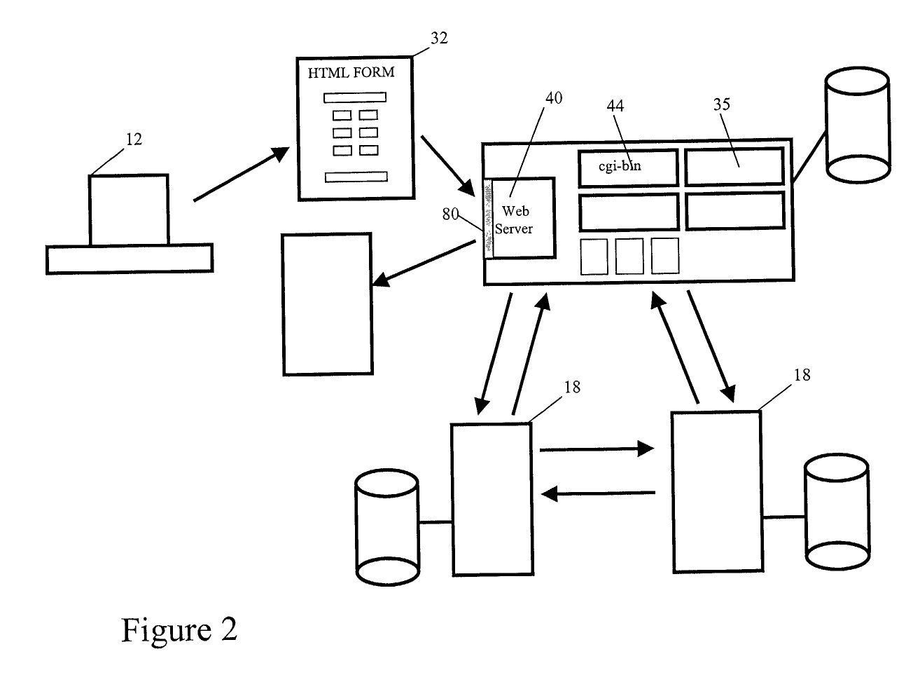

FIG. 2 provides a functional block diagram of one embodiment of a server system 14 for flexibly managing one or more VCSs 18. FIG. 2 further depicts the data flow diagram of one example of a subscriber's use of the server system 14 to manage one or more CVSs 18 from one or more telecommunications providers. Specifically, FIG. 2 depicts a data flow diagram wherein a subscriber 12 employs a GUI 32 (as previously discussed) to provide subscriber input, such as the previously discussed access and control information, to the server system 14. As can be seen from FIG. 2, the server system 14 acts as middleware that: coordinates the operations of the ASR/NLU application 35 in accessing the one or more CVSs 18; flexibly manages the one or more CVSs 18; and/or provides the subscriber with notification features beyond those available from the one or more CVSs 18. Specifically, FIG. 2 depicts the server system 14 as a functional block diagram that includes a Web server 40, an ASR/NLU application module 35, and a cgi-bin directory 44. The Web server 40 can be any suitable Web server, as discussed above, and in this example, can be understood as the Apache Web server listening to port 80 and having access to a set of executable files stored in a directory accessible to the Web server 40 such as the cgi-bin directory 44. One such executable file may be a script(s) and/or program(s) that implements the ASR/NLU application 35. The ASR/NLU application 35 may be a Perl V script, a C language program, a Java application, or any other suitable program.

The design and development of the ASR/NLU application 35 follows from principles known in the art of computer programming, including those set forth in Wall et al., Programming Perl, O'Reilly & Associates (1996); and Johnson et al, Linux Application Development, Addison-Wesley (1998).

FIG. 2 further depicts that the client process, or the GUI 32, forms one or more connections to an HTTP server listener process. The HTTP server process can be any suitable server process including the Apache server. Suitable servers are known in the art and are described in Jamsa, Internet Programming, Jamsa Press (1995), the teachings of which are herein incorporated by reference. In one embodiment, the HTTP server process serves HTML pages representative of search requests to client processes making requests for such pages. An HTTP server listener process can be an executing computer program operating on the server 14 and which monitors a port, typically well-known port 80, and listens for client requests to transfer a resource file, such as a hypertext document, an image, audio, animation, or video file from the server's host to the client process host. In one embodiment, the client process employs the HTTP protocol wherein the client process 32 transmits information that specifies the access information for a VCS 18 (as discussed above) and the control information for a VCS 18 (as discussed above). The HTTP server listener process detects the client request and passes the request to the executing HTTP server processors. It will be apparent to one of ordinary skill in the art, that although FIG. 2 depicts one HTTP server process, a plurality of HTTP server process can be executing on the server 14 simultaneously.

Accordingly, although FIGS. 1 and 2 graphically depict the system 10 and the ASR/NLU application 35 as functional block elements, it will be apparent to one of ordinary skill in the art that these elements can be realized as computer programs and/or computer hardware modules. Moreover, although FIG. 1 depicts the system 10 as including a server 14 coupled to a data processing system 16, it will be apparent to those or ordinary skill in the art that this is only one embodiment, and that the invention can be embodied as one or more computer programs and/or computer hardware components. Accordingly, it is not necessary that the server 14 be directly coupled to the data processing system 16, and instead, data can be accessed by any suitable technique, including by file transfer over a computer network. Further, the ASR/NLU application can be realized as a software component operating on a conventional data processing system such as a Unix workstation. In that embodiment, the ASR/NLU application can be implemented as a C language computer program, or a computer program written in any high level language including C++, Fortran, Java or basic. Additionally, in an embodiment where microcontrollers or DSPs are employed, the ASR/NLU application can be realized as a computer program written in microcode or written in a high level language and compiled down to microcode that can be executed on the platform employed. The development of processing systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983).

As described herein, the present invention enables a subscriber to flexibly access and manage multiple VCSs from one familiar interface, such as a Web-based GUI, in both real-time and non-real-time. Through this interface, the subscriber can program the system so that it automatically interacts with a VCS, and in doing so, significantly extends the notification and retrieval features of the VCS. It is further contemplated that the system can interact with a Unified Messaging Center, such as the system disclosed by the U.S. patent application Ser. No. 09/565,190 entitled “Unified Messaging System,” filed on May 3, 2000. It is yet further contemplated that the system can interact with a stand alone answering machine (e.g., a home answering machine). It is yet further contemplated that the system can interact with a communications/information service wherein the voice prompts are actually generated by an actual human being in real-time. It is yet further contemplated that the system can interact with a bank by phone voice application to, for example: notify a subscriber when her bank balance goes above or below a certain amount; and/or to allow the subscriber to access the bank by phone voice application on a different media (e.g., a PC system). It is yet further contemplated that the system can interact with a stock quotation voice application. It is yet further contemplated that the system can interact with all types of electronic agents that employ voice-prompts and are configured to receive voice commands, speech, DTMF transmissions, and/or pulse transmissions. It is yet further contemplated that the system can interact with any of the above stated systems and translate voice prompts and communications from one language to another.

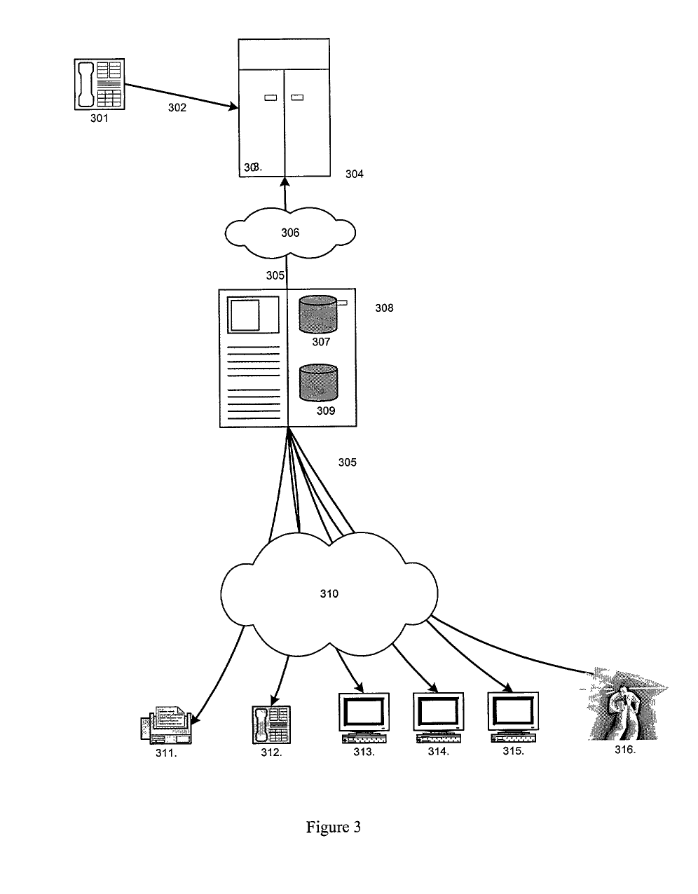

In FIG. 3, an embodiment of a system of the invention containing software is able to detect if a voice mail system (external to the system containing the invention) has messages and act accordingly. A call can be made to a telephone 301, for example.

The caller is diverted 302 to a voice mail (or unified messaging) system 303 (external to the system hosting the software using the invention).

The caller can leave a voice mail message in a voice mailbox or a record of the call can be entered. (The voice mailboxes may have a message in them for other reasons than described above).

The external system 304 hosts voice mailboxes. Some mailboxes may have voice messages, others may not. In one instance, it may be any voice mail system from many different vendors for which system 305 described below may or may not have information.

The system 305 hosting the software using the invention can retrieve messages or other information from the voice mail system 304.

A telephone network can connect the retrieval system 305 with the voicemail system 304.

Database (or databases) 307 contains tables (or other structures) of subscribers' information, the profiles of external voice services and a schedule.

The system 305 contains software that regularly examines the database 307. If the time specified in the schedule for a subscriber has been reached, the system 305 automatically calls a telephone number (usually found in the subscriber information within the database). Based on the profile in database 307 the system 305 accesses the voice mail box (by, for example entering the DTME digits for the mailbox number, password and any other information required to access the mailbox). The software running on the system 305 is able to understand the prompts played back by the external voice mail system, for example “you have one new message”, “you have no new messages”, “you have five new messages, one of which is urgent and three saved messages”. (Recognition of the voice prompts from the external system using natural language understanding or even speech recognition included in the invention.)

Based on the information retrieved from the external voice mail system and the profile of the subscriber, the system 305 may optionally store the results in another database 309, to be able to act upon it.

The system 305 may use the information obtained in 308 to attempt to send a notification to the subscriber. The notification may take the form of (for example):

Automatically sending a fax to a fax machine 34 to which the subscriber has access (the details of which such as its telephone number could be stored in database 307 and associated with the subscriber. The fax message could for example, contain the text “You have five messages in your voice mail box”.

Automatically initiating a new telephone call 312 (the details of which, such as the telephone number could be stored in database 307 and associated with the subscriber. When the called telephone is answered, the system 305 could authenticate the person as the subscriber (by asking him/her to enter a password, for example) and then play back for example “there are five messages in your office voice mail box.” The system 305 could offer additional services, such as asking the subscriber if he/she would like to be connected to the external voice mail systems to listen to the messages.

Sending an e-mail to an e-mail address 313 associated with the subscriber, usually obtained from the database 307. The message could contain the text, for example “You have five messages in your office voice mail box”.

Sending an instant message (IM) 314 to an address associated with the subscriber, usually obtained from the database 307. The message could contain the text, for example “You have five messages in your office voice mail box”.

Be stored for later retrieval from a web browser 315 or other device. For example, a web portal personal home page may have a line containing the text “You have five messages in your office voice mail”.

Any other device or mechanism 316 to inform the subscriber he/she has messages may be utilized, including those not commonly utilized or even invented at this time.

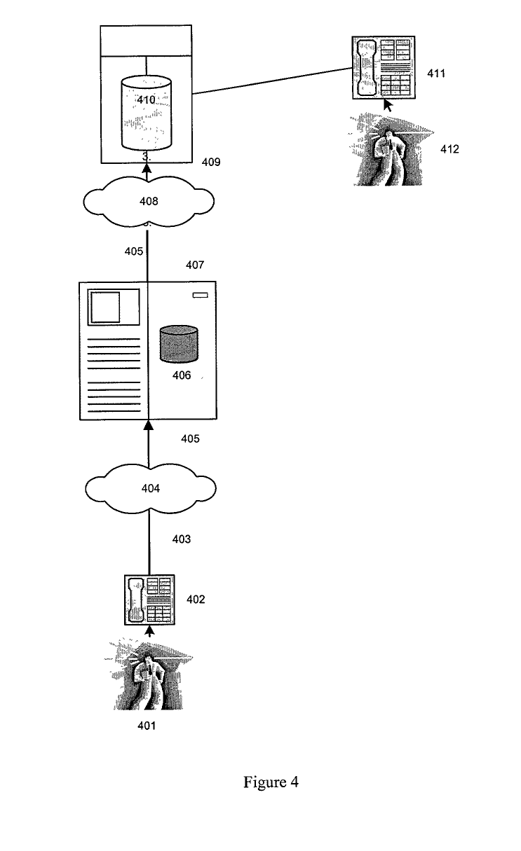

FIG. 4 shows how a person could navigate an external voice mail system more easily than using the telephone interface provided by the vendor or service provider of the voice mail system.

A person 401 makes a telephone call 403 from telephone 402 a system 404 or any voice client interface including a P.C. running a voice over IP client. In another variation, the person 401 may receive a telephone call from system 405.

The telephone call 403 is made over any public or private network 404 capable of initiating and managing a voice session (including a public or private networks using analog, digital or voice over IP technology).

The system 405 contains hardware and software capable of answering a telephone call and can prompt the caller with synthesized or pre-recorded voice prompts. The person 401 can interact with system 405 by, for example speaking words or phrases (recognized by system 405 using automatic speech recognition) or entering telephone keypad (DTMF) digits.

The system 405 may contain (or be connected to another system that contains) a database 406 of subscriber information such as user ID, passwords and external voice mail service information. The external voice mail service information contains, for example a telephone number which is used to call in to the external voice mail system and the user ID (mailbox number) and password of the person's account (voice mailbox) on external voice mail system. In other variation, this information could be entered by the person 401 at the time he/she makes the telephone call 403.

If the person 401 is a subscriber, he/she is authenticated to access system 405. This could be performed by the person 401 being prompted by the system 405 and entering a user ID, password. In a variation where the person 401 is not a subscriber (or the system 405 does not support subscriptions), authentication may be performed by the person 401 entering billing information such as a credit card number. In another variation, authentication could be minimal and the person could be allowed to access the system 405 immediately after calling the access number.

While the person 401 is connected to system 405, software running on system 405 initiates and manages a voice session 407 (for example by making a telephone call or initiating and managing a voice session using any technology) to the external voice mail, voice messaging, unified messaging or unified communications system 409. Typical designs of voice mail system 409 contain (or are connected other systems which have) a database of subscribers 410 and their messages 411 which as voice and (in the case of unified messaging systems) other kinds of messages such as e-mail and fax messages.

The voice mail system 409 is external to the system 405. It accepts (and makes) telephone 411 calls, normally from (or to) subscribers or people 412 wishing to deposit messages. People 412 calling and interacting with system 409 normally listen to synthesized or pre-recorded voice prompts, enter telephone keypad digits, or speak commands. Those people 412 calling recognize and act upon these commands, which result in other prompts being played or information such as voice or e-mail messages to be played back to the caller.

The System 405 acts as if it was a person calling the voice system 409. System 405 may or may not have any knowledge of how a person normally interacts with system 409 using a telephone. Using a key part of the invention, it receives voice prompts from system 409. Using speech recognition (SR), usually in combination with the more advanced features available with natural language understanding (NLU), the system 405 can recognize what the voice prompt is saying. By this it means that system 405 has a variety of actions it can take depending on what voice prompt it hears.

For example after the system 405 logs in to a voice mailbox, it may hear a prompt from the external voice mail system 409 that says for example “You have five new messages. To listen to your messages press one”. (Different external voice mail systems may have different ways of saying the same information, for example, another voice mail system may say “There are five voice messages in your mailbox. If you wish to listen to these messages say ‘yes’ now”. Using SR and NLU System 405 understands the many possible combinations of information played back and acts accordingly.

So acting as an agent for the person 401, the system 405 could navigate the external voice mail system 409 of his behalf. This could allow the person calling to use simplified commands that system 405 understands and which are interpreted into commands which system 409 understands.

For example, the person 401 in a session with system 405 could say “play me back all my new messages and save them”. Acting as a surrogate on behalf of the person 401, system 405 could navigate to the first message (in the two previous examples, by automatically playing the DTMF tone for the number 1 or saying “yes”) then play it back to the person 401. System 405 would then listen to the prompt from system 409 that describes how to save a message (for example, the prompt on system 409 may say “to save the message, press 3, or “say ‘save’ now to save this message”.) System 405 then would send (using DTMF tones or using synthesized or prerecorded voice command) the command required which saves the message. All the commands required by system 409 to play back to the user and save the messages are performed by system 405.

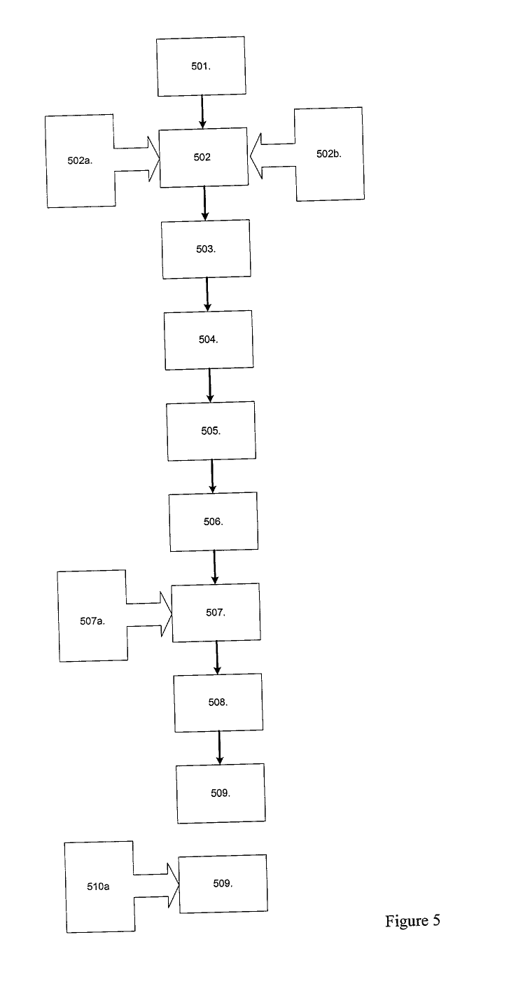

Turning now to FIG. 5, an embodiment of a method of the invention for automatically managing a VCS in showing. Based on an occurrence of event, such as a scheduled time has been reached, or a person accesses the system a process starts performing a set of operations 501.

The system determines which external voice application to access and how to access it 502. That is, the system has some basic information on how to interact with it on behalf of a user. It may retrieve information on how to do this from a database of subscriber profiles (502a.), interactively from a subscriber (502b.) or from other sources (502c.). The information obtained may include a telephone number to dial to access the external voice application (or perform the equivalent session initiation using alternative technology such as voice over IP), the user id or mailbox number, (if required), the access password (if required) and possibly rules for the use of this information.

The system and the external voice application form a two-way voice connection 503. This may be performed by the system dialing the telephone number or otherwise initiating a session with the external voice application. It may also retrieve the rules that determine how to use this data. In another variation, the session initiation may be reversed. That is, the external voice system may initiate the session and connect to this system.

At this point, the system may use one or more of the user id, the password and the rules to sign in (if required) to the voice application 504. This may be performed using the key part of the invention (see 506 below) or by other means.

The external voice system plays voice prompts which a user would hear 505. The voice prompts request input in the form of DTMF or touch-tone (telephone keypad) digits or spoken commands. For example “You have three new messages. To listen to your messages press one”, or “You have three new messages. To listen to your messages, say listen now”. Different voice applications from different vendors and service providers utilize different prompts and require different commands used to navigate the system.

At this point, the system preferably navigates the external voice application. The system can act on behalf of the user. Using standard or proprietary telephony hardware and software, the system retrieves the voice prompts. Using standard or proprietary automatic speech recognition (ASR) hardware or software and optionally natural language recognition (NLU) hardware or software, the system extracts information from the external voice application.

The information that is retrieved 507 from the external voice application is compared against rules stored on the system (507a.). A match is made with a rule that matches the voice prompt. The rule has an action associated with it, usually based on the user's preferences or request. For example, if the system has knowledge (coded, configured or obtained from the user) that it is communicating with a voice mail system, it could have configured or programmed within it a set of features available to most voice mail applications and rules for what to do with that feature on behalf of a given user.

Extending the method described in 505 above, the user's profile may request that voice messages in the external voice application should be retrieved and recorded by the system 508. In this case, it could be configured or coded to scan for the phrase “listen to”. It may configured or coded with all the alternative words or phases meaning the same as “listen to”, for example “review”, “play”, “hear” and utilize speech recognition to spot these words or phrases. Optionally in addition, using natural language understanding, the “word spotting” that speech recognition provides could be enhanced to recognize the meaning of whole sentences. The system would then have an associated action configured or coded for each of these sets of phrases. In the first example given in 505 above, given that the system would need to “listen” to the messages to record them, it would send the DTMF tone for the one key over the telephone connection to the external voice mail application. More than one rule may need to be matched to access the required feature and perform the required action.

In the example described in 505 and 507 above, once the rule that has determined that the message is being played back over the voice connection, the system would start recording the message 509. It would then execute a rule which attempt to match the end of the voice message. The rule could use speech recognition and natural language understanding to attempt to find a phrase with an equivalent meaning as “End of message”, or “to save this message” or “next message”. At this point it would stop recording the voice message. The system could then store the message on behalf of the user.

Extending the method described for 506, 507 and 509 above, the system could be configured to create an e-mail message to an address configured in the user database with the extracted voice message included as, for example an attachment 510.

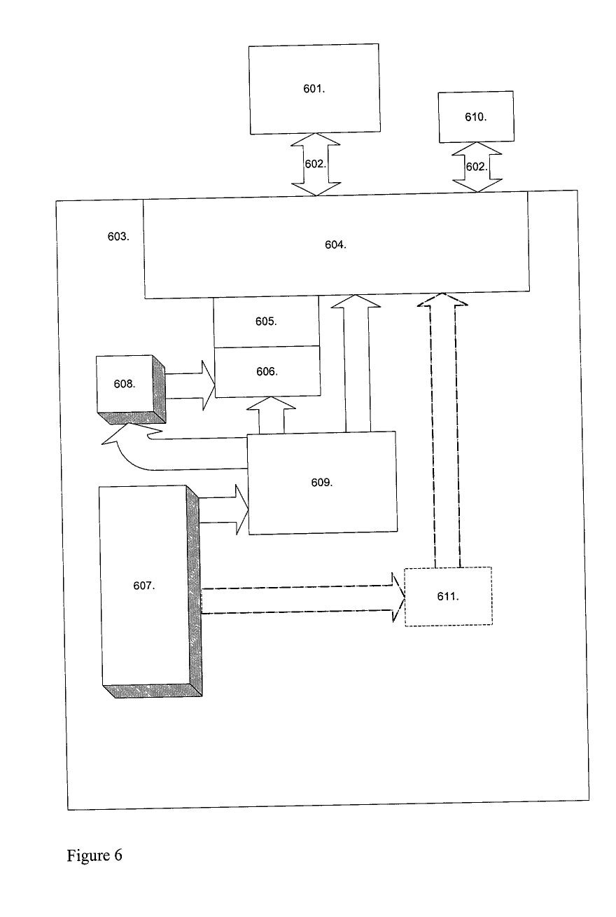

FIG. 6 is a block diagram showing an embodiment of a device the invention. An external voice system 601 or device capable of playing back information that can be listened to (that is, audio information). Normally this is an interactive voice response (IVR) system (also known as a voice response unit (VRU)), a voice portal, a voice mail system, a unified messaging (UM) system or a unified communications (UC) system. The IVR or VRU could be running one or more applications such as bank-by-phone or an automated stock brokerage service. The voice system could also be a telephone answering machine device that allow messages or other information to be played back over a telephone network—the “remote message retrieval” feature of some answering machines. These voice systems are designed to be accessed directly by a user, who may be a subscriber to a service running on the voice system, a casual user or the owner of the device or system. The external voice system plays back voice prompts and messages (containing either recorded or synthesized voice). These voice prompts may deliver some information and request some for of input from the user. The internal architecture of this system does not have to be known and is not described. In fact a part of this invention is that only a little information needs to be known about this external system, such as the type of system or application that it is running, the telephone number (or equivalent) required to access it, possibly a user id (or equivalent such as a mailbox or account number), and a user's password. Little or no other information about the voice prompts and commands utilized by the voice system need be known. The external system could be any standard, commodity or proprietary computer hardware running on one or more platforms capable of communicating to a telephone network. This system (or these systems) could run, for example any version of UNIX from any UNIX vendor, Linux or Microsoft Windows 2000, with telephony hardware from a company such as Dialogic Corporation (a subsidiary of Intel Corporation) to communicate with the telephone network and one or more applications running to provide the voice service.

A telephone network 602 connects the external voicemail to the telephone hardware/software of the invention. In this description, a “telephone network” is any network capable of initiating and managing a two-way voice-capable session with an external device or system. “Voice-capable” means the systems or devices at either end can send and receive voice by utilizing this network. The telephone network could be for, example the public switched telephone network (the PSTN), a private telephone network, a voice over IP network or any combinations of these.

The system 603 in an embodiment of the invention. This could be any standard or proprietary computer hardware running on one or more platforms. This system (or these systems) could run, for example any version of UNIX from any UNIX vendor, Linux or Microsoft Windows 2000, for example.

Telephony hardware and/or software 604 in an embodiment. This can be the standard or proprietary hardware and software (possibly more than one component) that allows the system to interface with a telephone network. It can initiate a two-way voice session (for example it can automatically dial a telephone number and detect the external device or answering the telephone call). It can receive voice and other audio information being sent from the external system or device. It can also detect other information sent along the telephone network, such as the tones sent from a telephone keypad (known as dual tone, multi-frequency or DTMF) as well as possibly the signal sent from rotary phones when the dial is turned when dialing a number (known as pulse detection). Other session control information such as if the terminating system or device disconnects (part of a set of features known as call progress detection). In the case of a telephone call coming in to the system through the telephone hardware. It may also be able to retrieve the calling party number—the telephone number of the device or system from where the call was initiated) and the called party number (the telephone number the external device ore system to access this system. In other voice capable networks (such as a voice over IP network) the systems or devices at the end-points may be identified by means other than telephone numbers, using for example the device identification used by Session Initiation Protocol (SIP). The telephony hardware may be inside the chassis of a system, possibly a hardware card (or cards) connected to the rest of the system over the a system bus (for example the PCI bus in an IBM-PC-compatible system) or a separate platform (or platforms) connected to the rest of the system by, for example an Internet Protocol (IP) network. An example of the telephony hardware that can be utilized in the system is a D41 telephony card manufactured by Dialogic Corporation, a subsidiary of Intel Corporation.

Speech recognition (“SR”) hardware or software module 605 connects the telephone unit 604 with the NLU module 606. Speech recognition is often known by the term automatic speech recognition (“ASR”). It is also sometimes incorrectly known as “voice recognition”. Since “voice” is associated with the speaker, voice recognition is not the recognition of spoken words but the recognition of the speaker. Although voice recognition (in the true meaning of the term) may be utilized by the system utilizing the invention, it is mainly speech recognition that is utilized. The hardware or software that performs the speech recognition could be a commodity or proprietary component (or components) running on one or more platforms included as part of the system. When requested, it receives voice sent over the telephone network through the telephony hardware and software as input. It then attempts to determine what words or phrases are in the voice communication and sends the text (or a token or tokens representing the text) as output back to the system. The SR module may be able to determine the whole content of the voice communication, or it may be able to return parts of it, usually based on words or phrases the SR module was configured to find within that particular voice communication. Speech recognition technology that could be utilized by this system includes software products from SpeechWorks International, Incorporated or Nuance Communications Incorporated.

A Natural Language Understanding (NLU) module 606 can be a commodity or proprietary hardware or software that takes text as input and determines its “meaning” (giving the system the ability to perform an action based on the content of the text. For example, natural language understanding could in theory allow a system to differentiate between the two sentences “The right way to go is to turn left at the traffic light.” and “After you have left, turn right at the traffic light.”. Note that in this example, speech recognition or looking for key words would not inform a system whether left or right is the correct direction to go at the traffic light. Many NLU systems require a context to be known before the text is scanned. The context may be encapsulated in a “grammar” which defines a set of rules, which when matched against the sentence or phrase can define a set of possible outcomes. In the example above assuming the system knows it is attempting to get driving directions, one simple rule could be to ignore the word “left or “right” unless is immediately preceded by “turn” or “go”. (Note in this example, the grammar would include many of these rules to be able to account for a large proportion of the ways to give directions.) Note that NLU may operate in conjunction with SR to simplify the process. An example of NLU software that could be utilized by this system is the Natural Language Speech Assistant (“NLSA”) product from Unisys Corporation.

An optional subscriber database 607, contains possibly a user id (607a.), a password (607b.), a profile of external voice services (607c.). The profile (607c.) may include the telephone access number (607d.) to access the external voice service, the user id (607e.) of the external voice system (or other user identifier such as the mailbox number or account number), optionally the user's password (607f.) for the external voice system, optionally the kind of external voice system (607g.) (for example, voice mail or stock brokerage IVR) service, what information is to be retrieved (607h.) from the external voice system (for example, a stock quotation for IBM) optionally when (607e.) to retrieve the information and what to do with the information (607f.) (for example deliver it in an e-mail message).

NLU rules 608 describe how to navigate the voice external system given only limited information such as the type of system it is (for example a stock quotation system) and what information needs to be obtained (for example retrieve a stock quote).

The application 609 (normally coded as software) runs on the system. This application controls the telephony hardware, the speech recognition and natural language understanding modules, optionally accesses a subscriber database, and the rules based on the type of external voice system, the state of the system and the optional profile of the user. It could be written in one or more programming languages such as C, C++, Visual Basic, Java or a proprietary language.

In some embodiments of this invention, a user may be accessing the system to control its operation 610 (see below). He/she may be using a telephone and accessing the system as an IVR, or utilizing another device such as a PC client or a web browser.

If the system accepts subscriptions from users, an optional user configuration and profile management module 611 would allow a user to set up his or her profile. The information that may be managed is described in 606. This module could be an internet (web), a client/server or an IVR or any other application capable of receiving and storing input from a user.

Interactions

An event occurs causing the application (609) running on the system containing a version of the patent (603) to operate on behalf of a user. The event may be caused by a periodic time interval elapsing, possibly obtained from the information stored in (607e), a user (610) accessing the system or another event. The system (610) utilizes the telephony hardware and/or software (604) to initiate and manage a session over the telephone network (602) with the external voice system (601). The external voice system (601) plays voice prompts, possibly requesting a user id obtained from (607e) and password obtained from (607f). While the voice prompts are being played, the application (609) uses SR (605) and optionally NLU (606) and the NLU rules (608) to navigate the external voice application (601).

For example if a user's profile determined that the application (609) should activate every hour and determine how many messages are in the voice mail box, the NLU rules (608) may contain one rule named (in a pseudo language) HOW_MANY_NEW_MESSAGES which can be used to determine how many messages are in a voice mailbox in a voice mail system. It could be described:

| RULE: HOW_MANY_NEW_MESSAGES: <m> | |
|---|---|
| FIRST OF { | |
| [<any text>] <n> URGENT [VOICE] MESSAGES AND <o> NEW [VOICE] | |
| MESSAGES [<any text>]: <m> = <n> + <o>; | |
| [<any text>] ONE URGENT [VOICE] MESSAGE AND <o> NEW [VOICE] | |
| MESSAGES [<any text>]: <m> = 1 + <o>; | |
| [<any text>] <n> NEW [VOICE] MESSAGES AND <o> URGENT [VOICE] | |
| MESSAGES [<any text>]: <m> = <n> + <o>; | |
| [<any text>] ONE NEW [VOICE] MESSAGE AND <o> URGENT [VOICE] | |
| MESSAGES [<any text>]: <m> = 1 + <o>; | |
| [<any text>] ONE URGENT [VOICE] MESSAGE AND ONE NEW [VOICE] | |
| MESSAGE [<any text>]: <m> = 2; | |
| [<any text>] <n> NEW [VOICE] MESSAGES [<any text>]): <m> = <n>; | |
| [<any text>] NO [NEW] [VOICE] MESSAGES [<any text>]): <n> = 0; | |
| [<any text>] <n> URGENT [VOICE] MESSAGES [<any text>): <m> = <n>; | |
| [<any text>] MESSAGES [<any text>]: <m> = 0 | |
| ELSE GO TO EXCEPTION_RULE | // rule to find out where we are in the |
| system | |
| }; | |

The pseudo language for the rule is provided as a generalized example of a rule. It is not based on an NLU system in practice and is not necessarily a complete rule. Capital letters within the rule mean this word or phrase may appear in the voice prompt. Any text in square bracket “[” and “]” means an optional word. Any text or letters in greater than “<” and less than “>” symbols are variables, some redefined system variables, others returned when the rule completes. Two slashes next to each other (“//”) defines the start of a comment, lasting until the end of the line.

Once the NLU rule competes, the variable or variables are returned. In this example, the number of new messages plus the number of urgent messages is returned. Based on the result from the rule, the application (609) can perform some action on behalf of the user such as notify him or her in an e-mail message that he/she has voice mail messages.

In addition, the variable returned from the NLU rule may be the DTMF digit or word to speak required to navigate to another state in the external voice system (602). For example if the user profile requested a message be recorded, the pseudo code for the rule may look something like:

| RULE: ACCESS_FIRST_MESSAGE <x> | |
|---|---|
| TO (LISTEN\|REVIEW\|PLAY [BACK]\|HEAR) YOUR [VOICE] MESSAGES | |
| PRESS\|SAY <x> [<any text>] | |
| ELSE GO TO EXCEPTION_RULE | // rule to find out where we are in the |
| system | |

Note in this pseudo code the pipe symbol “|” means pick one from the set (that is, an OR condition) and text in parentheses “(” and “)” defines precedence in association with consecutive text.

In this simple application, the variable <x> returned could then be either spoken by the application (609.) if it is text, or the associated DTMF tone generated and played, if it is a number.

The NLU rules could be more detailed and complicated depending on the complexity of the VCS. The NLU rules would also be written in the native rule language of the NLU module (606) and not pseudo code. In a simple application where NLU was not utilized, a scripting language provided with the SR software or hardware (605.) could provide similar functionality, albeit a lot more simplistically and probably less reliably.

As with many SR and NLU -enabled voice applications, the system (603) could learn from any exceptions, or be trained by the user to navigate the external voice system (602) possibly using the user management and configuration module (611).

Those skilled in the art will know or be able to ascertain using no more than routine experimentation, many equivalents to the embodiments and practices described herein. It will also be understood that the systems described herein provide advantages over the prior art including the ability to flexibly access, monitor, and manage a VCS without being confined by the proprietary technology of a particular telecommunications provider. Accordingly, it will be understood that the invention is not to be limited to the embodiments disclosed herein, but is to be understood from the following claims, which are to be interpreted as broadly as allowed under the law.

The following references describe general background information which provide guidance in practicing the invention disclosed herein. U.S. Pat. No. 3,943,295 to Martin, et al. for “Apparatus and method for recognizing words from among continuous speech”; U.S. Pat. No. 5,572,570 to Kuenzig for “Telecommunication system tester with voice recognition capability”; U.S. Pat. No. 5,799,276 to Komissarchik, et al for “Knowledge-based speech recognition system and methods having frame length computed based upon estimated pitch period of vocalic intervals”; U.S. Pat. No. 5,835,565 to Smith, et al. for “Telecommunication system tester with integrated voice and data”; U.S. Pat. No. 5,995,918 to Kendall, et al., for “System and method for creating a language grammar using a spreadsheet or table interface”; U.S. Pat. No. 6,094,635 to Scholz, et al, for “System and method for speech enabled application”; and U.S. Pat. No. 6,091,802 to Smith, et al. for “Telecommunication system tester with integrated voice and data.”

What is claimed is:

1. A method for receiving information from a Voice-Based Communications System (VCS) account, having a voice-based interface that transmits voice-prompts and receives responses thereto, the method comprising:
providing an Automatic Speech Recognition and Natural Language Understanding application (ASR/NLU application) with access data and control data for the VCS account;
communicating between the ASR/NLU application and the voice-based interface; and
employing the ASR/NLU application to respond to the voice-based interface so as to receive information from the VCS account.

2. The method of claim 1, wherein employing the ASR/NLU includes responding to the voice based interface using at least one of an audio tone, a DTMF tones, a pulse tone, a synthesized voice, and a pre-recorded voice.

3. The method of claim 1, wherein the access and control data for the VCS account is provided from a computer database to the application.

4. The method of claim 1, wherein communicating between the ASR/NLU application and the voice based interface occurs through a communications network.

5. The method of claim 1, wherein the communicating between the ASR/NLU application and the voice based interface occurs through a public switched telephone network, a private telephone network, a wireless telephone network, a voice carrier over a data protocol, or voice over IP.

6. The method of claim 1, further comprising notifying a VCS account subscriber that information has been received by the VCS account.

7. The method of claim 6, wherein notifying the subscriber includes subsequently allowing the subscriber to receive the information from the VCS account.

8. The method of claim 7, wherein allowing the subscriber to receive the information from the VCS account includes receiving information from the VCS in real-time or from a second storage device.

9. The method of claim 6, wherein the step of notifying includes notifying by at least one of facsimile, instant messaging, email, an updated web page, a page, a wireless access device and a telephone call.

10. The method of claim 1, wherein the information is a financial information, a voice message, a stock quote, news, entertainment information, a sports score, a horoscope, a prediction, or a reminder.

11. The method of claim 10, wherein the information from the VCS is provided on a fee per call basis.

12. The method of claim 6, wherein the subscriber is prompted to enter an access code to receive the notification.

13. A system for managing a Voice-Based Communications System (VCS) account, having a voice-based interface that transmits voice-prompts and receives responses thereto, the system comprising:
an Automatic Speech Recognition and Natural Language Understanding application (ASR/NLU application);
a transceiver to communicate information between the VCS account and the application; and
a database to store the information received by the application from the VCS account.

14. The system of claim 13, wherein the system includes the transceiver being configured to communicate with a client through a communications network and the application being configured to provide the client with the information received by the application from the VCS account.

15. The system of claim 14, wherein the application is configured to receive from the client the VCS account access data and VCS account interface control data.

16. The system of claim 13, wherein the system is configured to provide an automatic notification to a user by at least one of a facsimile, an instant message, an email, an updated web page, a page to a beeper, a wireless access device and a telephone call.
